(19) United States
(12) Patent Application Publication
(10) Pub. No.: US 2014/0344432 A1
(43) Pub. Date: Nov. 20, 2014

(54) IMAGE FORMING APPARATUS, IMAGE FORMING METHOD, AND NON-TRANSITORY COMPUTER READABLE MEDIUM

(71) Applicant: FUJI XEROX CO., LTD, Tokyo (JP)

(72) Inventor: Akira OKAMOTO, Kanagawa (JP)

(73) Assignee: FUJI XEROX CO., LTD, Tokyo (JP)

(21) Appl. No.: 14/205,545

(22) Filed: Mar. 12, 2014

(30) Foreign Application Priority Data
May 20, 2013 (JP) 2013-106613

(51) Int. Cl. H04L 12/24

(52) U.S. Cl. CPC H04L 41/00
USPC 709/223

(57) ABSTRACT

An image forming apparatus includes plural communication interfaces and an associating unit. The plural communication interfaces each communicate with any of plural networks. The associating unit associates terminal identification information regarding a terminal connected to any of the networks with any of the plural communication interfaces which communicates with the network to which the terminal is connected.

### CROSS-REFERENCE TO RELATED APPLICATIONS

This application is based on and claims priority under 35 USC 119 from Japanese Patent Application No. 2013-106613 filed May 20, 2013.

### BACKGROUND

### Technical Field

The present invention relates to an image forming apparatus, an image forming method, and a non-transitory computer readable medium.

### SUMMARY

According to an aspect of the invention, there is provided an image forming apparatus including plural communication interfaces and an associating unit. The plural communication interfaces each communicate with any of plural networks. The associating unit associates terminal identification information regarding a terminal connected to any of the networks with any of the plural communication interfaces which communicates with the network to which the terminal is connected.

### BRIEF DESCRIPTION OF THE DRAWINGS

An exemplary embodiment of the present invention will be described in detail based on the following figures, wherein:

FIG. 1 is a diagram illustrating a hardware configuration of an image forming apparatus according to an exemplary embodiment of the present invention;

FIG. 2 is a diagram illustrating an example of a domain name system (DNS) name management list according to the exemplary embodiment;

FIG. 3 is a diagram illustrating examples of Dynamic Host Configuration Protocol (DHCP) packets according to the exemplary embodiment;

FIG. 4 is a diagram illustrating examples of DNS packets according to the exemplary embodiment; and

FIG. 5 is a flowchart illustrating an example of a flow of read image transmission processing according to the exemplary embodiment.

### DETAILED DESCRIPTION

An exemplary embodiment of the present invention will be described with reference to the figures.

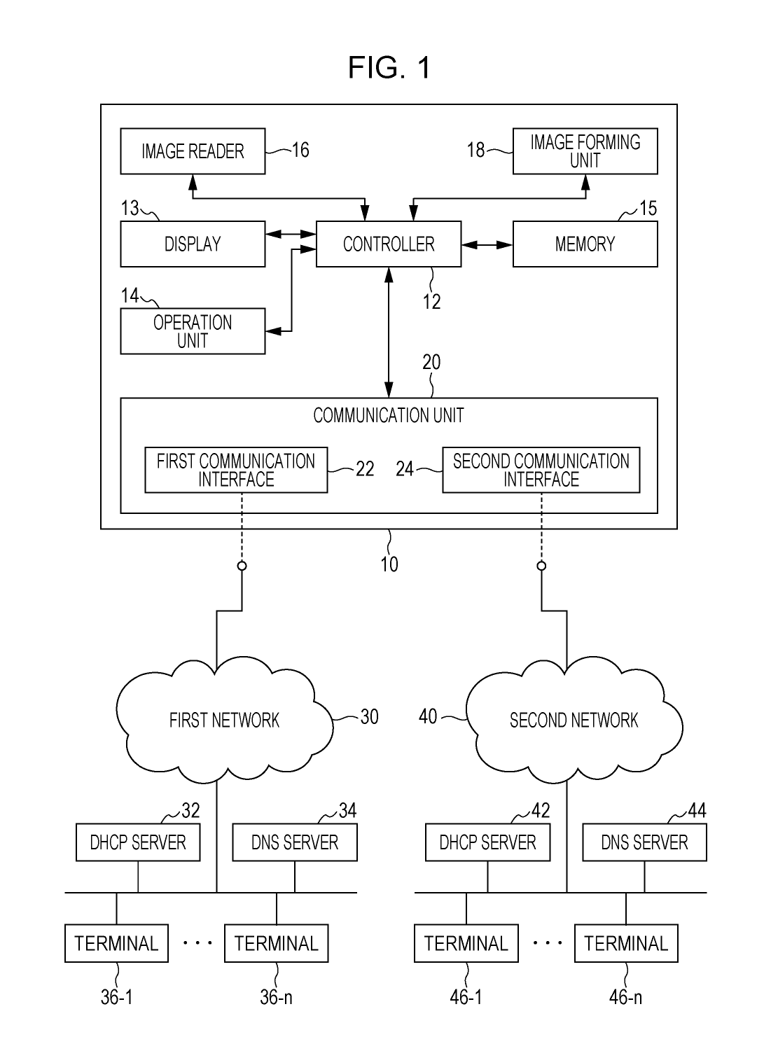

FIG. 1 is a diagram illustrating a hardware configuration of an image forming apparatus according to an exemplary embodiment of the present invention. As illustrated in FIG. 1, an image forming apparatus 10 includes a controller 12, a display 13, an operation unit 14, a memory 15, an image reader 16, an image forming unit 18, and a communication unit 20.

The controller 12 includes a central processing unit (CPU). The controller 12 controls each unit of the image forming apparatus 10 by executing a program stored in the memory 15.

The display 13 is a liquid crystal display panel, for example, and the operation unit 14 is a touch panel, for example.

The memory 15 is constituted by various memories, such as a hard disk and a random access memory (RAM). The memory 15 is a storage medium that stores a program executed by the controller 12, for example. Additionally, the memory 15 is used as a work memory of the controller 12, for example. Note that various memories are applicable to the memory 15. For example, the memory 15 may be implemented by using a storage device, such as a semiconductor memory, for example. In the exemplary embodiment, the memory 15 specifically stores a DNS name management list. The details of the function of a DNS name management list will be described below.

Note that, in a description given below, it is assumed that a program and various types of data are stored in the memory 15 in the exemplary embodiment, however, a program and various types of data may be obtained from an external apparatus via the communication unit 20 or may be obtained from an external storage medium.

The image reader 16 is constituted by a scanner or the like. The image reader 16 generates an image of a scan object, such as a sheet, by optically scanning the scan object. The image forming unit 18 is constituted by a printer or the like. The image forming unit 18 forms an image on a recording medium (for example, a sheet or a film) on the basis of image data obtained from the image reader 16 or the communication unit 20.

The communication unit 20 is constituted by a network interface card (NIC) or the like and performs wired or wireless data communication with an external apparatus connected to the image forming apparatus 10. In the exemplary embodiment, the communication unit 20 includes plural communication interfaces. Here, an example will be given and described in which the communication unit 20 includes two communication interfaces (a first communication interface 22 and a second communication interface 24), however, any number of physical interfaces may be included in the communication unit 20. The first communication interface 22 and second communication interface 24 each communicate with any of plural types of networks. In the exemplary embodiment, a description will be given while taking an Internet service provider (ISP) and an intranet as examples of plural types of networks.

Communication interfaces (the first communication interface 22 and second communication interface 24) are devices used to communicate with other apparatuses (for example, a DHCP server, a DNS server, and a terminal) over a network. As illustrated in FIG. 1, the first communication interface 22 is connected to a first network 30 (here, an ISP) and is able to communicate with a DHCP server 32, a DNS server 34, and terminals 36 (36-1 to 36-n). The second communication interface 24 is connected to a second network 40 (here, an intranet) and is able to communicate with a DHCP server 42, a DNS server 44, and terminals 46 (46-1 to 46-n). More specifically, the first communication interface 22 passes data received from any of the terminals 36 to the controller 12. Furthermore, the first communication interface 22 transmits data received from the controller 12 to any of the terminals 36. The second communication interface 24 has a function similar to that of the first communication interface 22 described above.

In the exemplary embodiment, the controller 12 of the image forming apparatus 10 is configured to select, when data obtained by the image reader 16 is to be transmitted to a desired terminal, a communication interface to which a destination terminal is connected, from among plural communication interfaces.

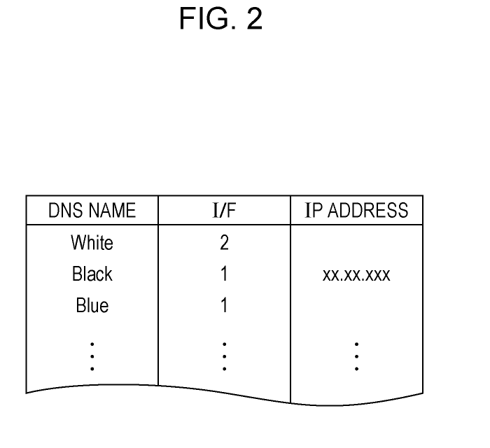

In the exemplary embodiment, a DNS name management list illustrated in FIG. 2, in which the DNS names of terminals connected to networks with which the image forming apparatus 10 is able to communicate are associated with communication interfaces that are able to communicate with the terminals, is stored in the memory 15 of the image forming apparatus 10. As illustrated in FIG. 2, a DNS name management list of the exemplary embodiment is managed such that the DNS name of a terminal that is able to communicate with the image forming apparatus 10 is associated with the identification number of a communication interface that is able to communicate with the terminal and the Internet Protocol (IP) address of the terminal having the DNS name. Here, in the exemplary embodiment, it is assumed that the DNS name of the terminal 36-1 is Black, the DNS name of the terminal 36-2 is Blue, and the DNS name of the terminal 46-1 is White. The DNS name management list as illustrated in FIG. 2 is generated by obtaining packets (for example, DHCP packets, DNS packets, or the like) flowing through each of plural communication interfaces that the image forming apparatus 10 has.

Here, an example of a technique for generating a DNS name management list by obtaining DHCP packets flowing through the second communication interface 24 that the image forming apparatus 10 has will be explained.

First, when the terminal 46-1 (DNS name: White) is connected to a network, the terminal 46-1 performs broadcasting and transmits a discover message throughout a network segment on which the terminal 46-1 resides. When the DHCP server 42 receives a discover message, the DHCP server 42 transmits an offer message to the terminal 46-1. An offer message contains information about an IP address available to the terminal 46-1 (an IP address that is not leased to other computers), the IP address of the DHCP server 42, vendor specific information, and the like. That is, the DHCP server 42 offers an IP address that is leasable to the terminal 46-1.

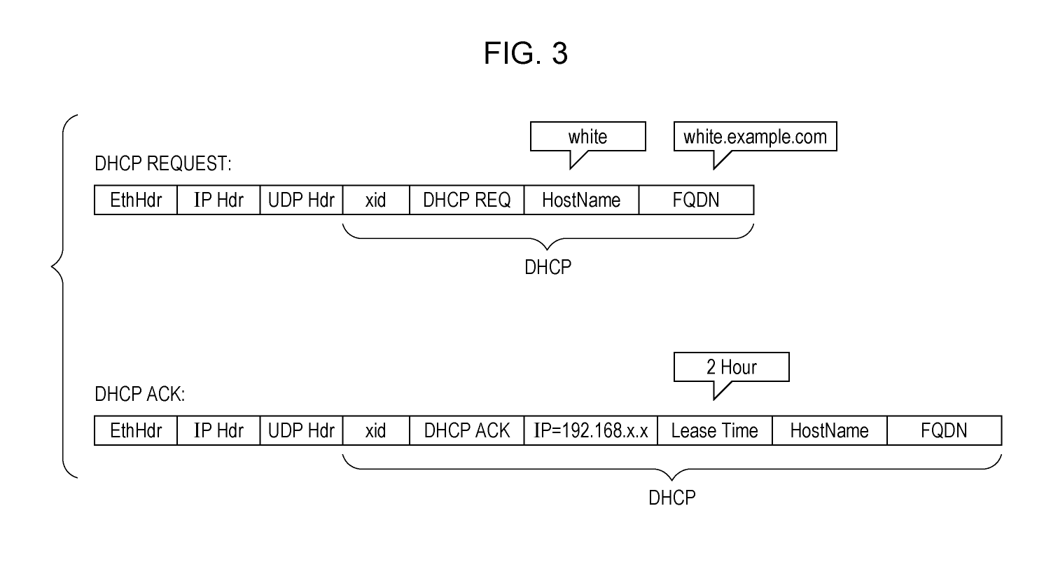

When the terminal 46-1 receives an offer message, the terminal 46-1 obtains an IP address contained in the offer message. Note that, in the case where the terminal 46-1 has received plural offer messages, an IP address contained in an offer message that has been received first is obtained. The terminal 46-1 transmits to the DHCP server 42 a request message as illustrated in FIG. 3 which contains the IP address that has been obtained.

When the DHCP server 42 receives a request message, the DHCP server 42 assigns an IP address to the terminal 46-1 in accordance with the content of the request message. The DHCP server 42 puts restriction so that other computers are not allowed to use the IP address assigned to the terminal 46-1. Then, the DHCP server 42 transmits to the terminal 46-1 an acknowledgement message as illustrated in FIG. 3 used to communicate formal assignment of an IP address. When the terminal 46-1 receives an acknowledgement message, the terminal 46-1 performs IP address setting processing in accordance with the content of the acknowledgement message and controls communication performed thereafter.

As described above, in the case where the terminal 46-1 obtains an IP address when being connected to a network, the terminal 46-1 transmits a request message and the like in a broadcast manner. As illustrated in FIG. 3, a request message contains an xid frame, a request frame, a HostName frame, and a fully qualified domain name (FQDN) frame. The controller 12 of the image forming apparatus 10 obtains such a request message via the second communication interface 24 and derives a DNS name (White) from the HostName frame, the FQDN frame (for example, white.example.com), and the like. Then, the controller 12 associates the derived DNS name White with an identification number 2, which indicates the second communication interface 24, and saves the DNS name and the identification number in a DNS name management list.

The controller 12 of the image forming apparatus 10 may obtain an acknowledgement message or the like transmitted by the DHCP server 42 to the terminal 46-1 and derive the IP address of the terminal 46-1. As illustrated in FIG. 3, an acknowledgement message contains an xid frame, an ack frame, an IP address frame, a LeaseTime frame (for example, 2 hours), a HostName frame, and an FQDN frame. The controller 12 of the image forming apparatus 10 receives such an acknowledgement message via the second communication interface 24 and derives a DNS name (White) and an IP address (for example, 192.168.x.x) from the IP address frame, the HostName frame, and the FQDN frame. Then, the controller 12 associates the derived DNS name White, the IP address 192.168.x.x, and the identification number 2, which indicates the second communication interface 24, with one another and saves the DNS name, the IP address, and the identification number in a DNS name management list. Note that there is a case where the HostName frame and the FQDN frame are not contained in an acknowledgement message. In such a case, it is possible to associate an IP address with a DNS name by using the xid frame, which has the same value in a request message and in an acknowledgement message.

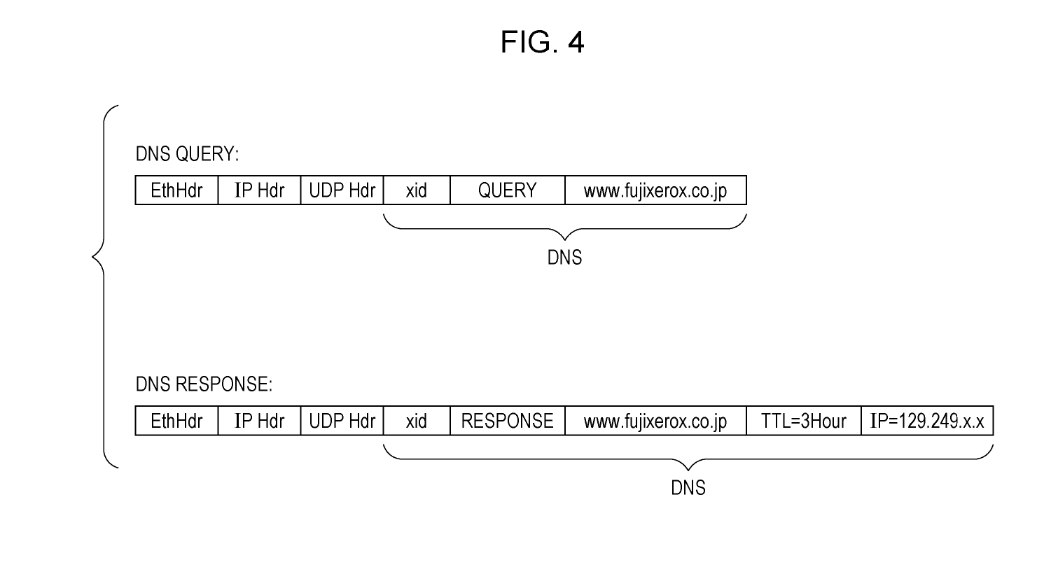

In addition to the case where each terminal obtains an IP address, the controller 12 of the image forming apparatus 10 may obtain via a communication interface, in the case where other nodes make a DNS query to a DNS server, for example, a query packet or a response packet illustrated in FIG. 4, derive a DNS name, associate the DNS name with the communication interface, and save the DNS name and information about the communication interface. As illustrated in FIG. 4, a DNS query packet contains an xid frame, a query frame, and a DNS name frame. A DNS response packet contains an xid frame, a response frame, a DNS name frame, a time to live (TTL) frame, and an IP address frame. The controller 12 of the image forming apparatus 10 derives a DNS name and an IP address from the DNS name frame, the IP address frame, and the like of such a query packet or a response packet and associates the DNS name with the IP address.

As described above, the controller 12 of the image forming apparatus 10 is configured to obtain DHCP packets and DNS packets addressed to a local node, addressed to other nodes, for broadcasting, and for multicasting and generate a DNS name management list. Communication interfaces via which packets are to be obtained may be all communication interfaces that the image forming apparatus 10 has or one or more communication interfaces that are selected as desired.

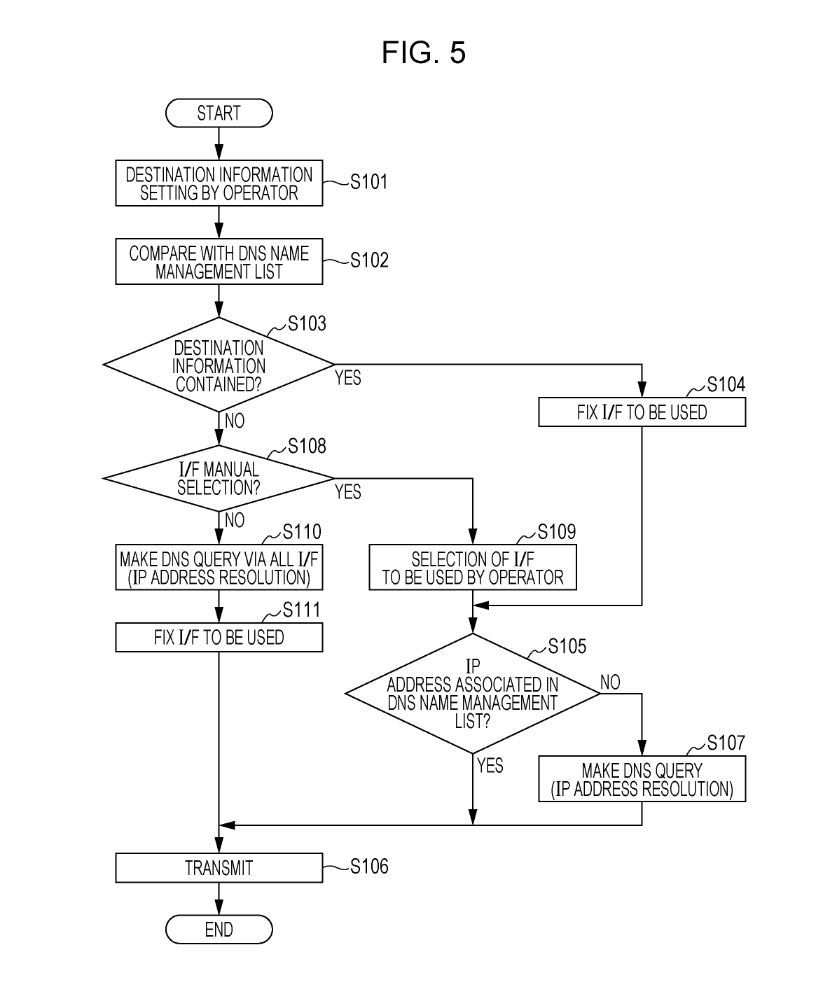

An example of a flow of read image transmission processing performed by the image forming apparatus 10 of the exemplary embodiment using a DNS name management list will be described with reference to a flowchart illustrated in FIG. 5.

First, when an image has been read by the image reader 16, the controller 12 starts to set a destination of data that has been read (step S101). More specifically, the controller 12 displays, on the display 13, a setting screen used to set a destination of data. A setting screen is displayed in the case where data that has been read by the image reader 16 is attached to an email and transmitted to a terminal on a communication network (that is, scan to mail), for example. A destination may be set before an image is read by the image reader 16. The controller 12 receives input made by an operator. More specifically, when an operator operates the operation unit 14 while viewing the setting screen displayed on the display 13, the controller 12 obtains information inputted by an operator from the operation unit 14. Information inputted by an operator includes destination information, a user name, a password, and the like, for example. Destination information may be an email address, an IP address, an FQDN, or the like. In the exemplary embodiment, it is assumed that the DNS name of a destination is set as destination information.

The controller 12 compares destination information (hereinafter assumed to be a DNS name) inputted by an operator in step S101 with information contained in a DNS name management list stored in the memory 15 (step S102) and determines whether or not information that corresponds to a DNS name inputted by an operator is contained in the DNS name management list (step S103).

If the controller 12 determines that a DNS name inputted by an operator is contained in the DNS name management list (YES in step S103), the controller 12 fixes a communication interface associated with the DNS name as a communication interface to be used (step S104).

Then, the controller 12 determines whether or not an IP address relating to the DNS name inputted by an operator is associated with the DNS name in the DNS name management list (step S105). If an IP address relating to the DNS name inputted by an operator is associated with the DNS name (YES in step S105), the controller 12 addresses data to the IP address and transmits the data via the communication interface fixed in step S104 (step S106).

If an IP address relating to the DNS name inputted by an operator is not associated with the DNS name (NO in step S105), the controller 12 makes a DNS query to a DNS server connected to the communication interface fixed in step S104 and obtains an IP address relating to the DNS name inputted by an operator (step S107). Then, the controller 12 addresses data to the IP address obtained in step S107 and transmits the data via the communication interface fixed in step S104 (step S106).

If the controller 12 determines, in step S103, that a DNS name inputted by an operator is not contained in the DNS name management list (NO in step S103), the controller 12 determines whether or not manual selection of a communication interface to be used is set (step S108).

If it is determined that manual selection of a communication interface to be used is set (YES in step S108), a communication interface to be used is selected by an operator (step S109) and the processing in and after step S105 is performed. Since the processing in and after step S105 is as described above, duplicated description thereof will be omitted here.

If it is determined that manual selection of a communication interface to be used is not set (NO in step S108), the controller 12 makes a DNS query, via all communication interfaces that the image forming apparatus 10 has, to DNS servers connected to respective communication interfaces and obtains an IP address relating to the DNS name inputted by an operator (step S110). Then, the controller 12 fixes a communication interface via which an IP address relating to the DNS name inputted by an operator has been obtained as a communication interface to be used (step S111). The controller 12 thereafter addresses data to the IP address that has been obtained and transmits the data via the communication interface that has been fixed (step S106).

Note that an exemplary embodiment of the present invention is not limited to the foregoing exemplary embodiment.

In the exemplary embodiment, the image forming apparatus 10 includes a memory and a controller, however, another apparatus, such as a server, may include a memory and a controller. In this case, information is transmitted and received via a communication unit.

Specific character strings and numeric values described above and specific character strings and numeric values described in the figures are examples and are not meant for limitation.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of communication interfaces that each communicate with any of a plurality of networks; and
an associating unit that associates terminal identification information regarding a terminal connected to any of the networks with any of the plurality of communication interfaces which communicates with the network to which the terminal is connected.

2. The image forming apparatus according to claim 1, further comprising:
an obtaining unit that obtains the terminal identification information from a communication packet that flows through at least one communication interface among the plurality of communication interfaces, wherein
the associating unit associates the terminal identification information that has been obtained by the obtaining unit with the at least one communication interface.

3. The image forming apparatus according to claim 1, further comprising:
an image reader that reads an image of a document; and
a transmitting unit that transmits, in accordance with a result of comparison between the terminal identification information of the terminal that is a destination of information regarding the image that has been read by the image reader and the terminal identification information associated with any of the plurality of communication interfaces by the associating unit, the information regarding the image to the terminal via any one of the plurality of communication interfaces.

4. The image forming apparatus according to claim 2, further comprising:
an image reader that reads an image of a document; and
a transmitting unit that transmits, in accordance with a result of comparison between the terminal identification information of the terminal that is a destination of information regarding the image that has been read by the image reader and the terminal identification information associated with any of the plurality of communication interfaces by the associating unit, the information regarding the image to the terminal via any one of the plurality of communication interfaces.

5. An image forming method comprising:
associating terminal identification information regarding a terminal connected to any of networks, each of the networks communicating with any of a plurality of communication interfaces, with any of the plurality of communication interfaces which communicates with the network to which the terminal is connected.

6. A non-transitory computer readable medium storing a program causing a computer to execute a process for image forming, the process comprising:
associating terminal identification information regarding a terminal connected to any of networks, each of the networks communicating with any of a plurality of communication interfaces, with any of the plurality of communication interfaces which communicates with the network to which the terminal is connected.
